(19) United States
(12) Patent Application Publication
(10) Pub. No.: US 2017/0107089 A1
(43) Pub. Date: Apr. 20, 2017

(54) Molding Removal Tool Assembly

(71) Applicant: Edward Lenart, Farmington Hills, MI (US)

(72) Inventor: Edward Lenart, Farmington Hills, MI (US)

(21) Appl. No.: 14/887,640

(22) Filed: Oct. 20, 2015

(51) Int. Cl. B66F 15/00; B25C 11/00; B25B 33/00

(52) U.S. Cl. CPC B66F 15/00; B25B 33/00; B25C 11/00

(57) ABSTRACT

A wall trim and molding removal tool assembly with a panel that has a top side, a bottom side, a front edge, a rear edge, a first lateral edge, and a second lateral edge. The panel has a bend therein extending between the first and second lateral edges. The panel has an opening therein positioned between the bend and the front edge. The opening has a forward edge and a rearward edge. The forward edge is adjacent to the front edge. A tab is attached to the forward edge of the opening in the panel. The tab is angled upwardly from the panel. The tab has an upper surface and a lower surface and an angle is formed between the upper surface and the top side that is between 135° and 175°. A grip is attached to the rear edge and extends away therefrom.

### BACKGROUND OF THE DISCLOSURE

### Field of the Disclosure

The disclosure relates to wall trim removal devices and more particularly pertains to a new wall trim removal device for assisting a person in removing either trim or molding from a wall surface.

### SUMMARY OF THE DISCLOSURE

An embodiment of the disclosure meets the needs presented above by generally comprising a panel that has a top side and a bottom side. The top side includes a front edge, a rear edge, a first lateral edge, and a second lateral edge. The front edge is angled downwardly from the top side to the bottom side such that a terminal edge is defined at a juncture of the top side and the bottom side to form a sharpened edge. The panel has a bend therein extending between the first and second lateral edges. The bend forms an obtuse angle in the top side. The panel has an opening therein positioned between the bend and the front edge. The opening has a forward edge, a rearward edge, a first side edge and a second side edge. The forward edge is adjacent to the front edge. A tab is attached to the forward edge of the opening in the panel. The tab is angled upwardly from the panel. The tab has an upper surface and a lower surface and an angle is formed between the upper surface and the top side that is between 135° and 175°. A grip is attached to the rear edge and extends away therefrom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a wall trim and molding removal tool assembly according to an embodiment of the disclosure.

FIG. 2 is a top view of an embodiment of the disclosure.

FIG. 3 is a side view of an embodiment of the disclosure.

FIG. 4 is a bottom perspective view of an embodiment of the disclosure.

FIG. 5 is a broken side view of an embodiment of the disclosure.

FIG. 6 is a broken perspective view of an embodiment of the disclosure.

### DESCRIPTION OF THE PREFERRED EMBODIMENT

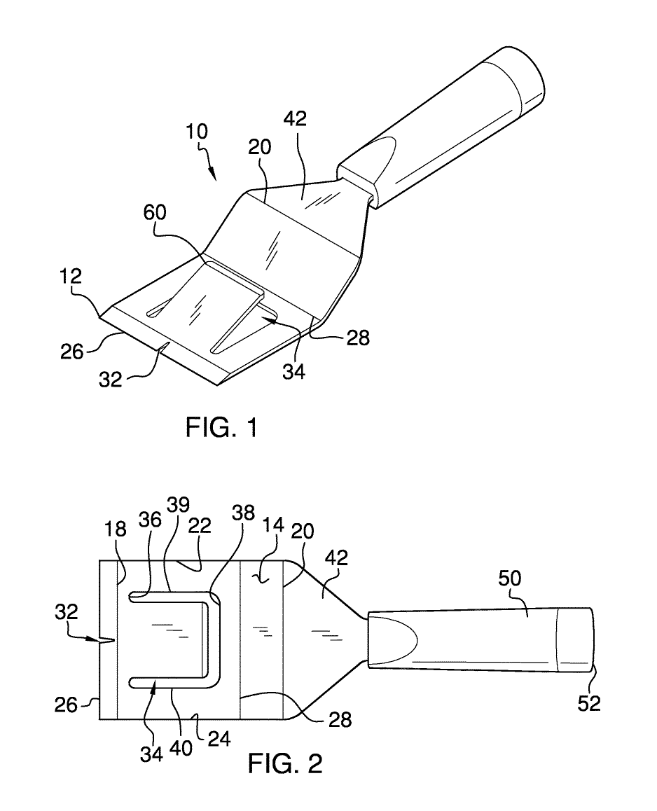

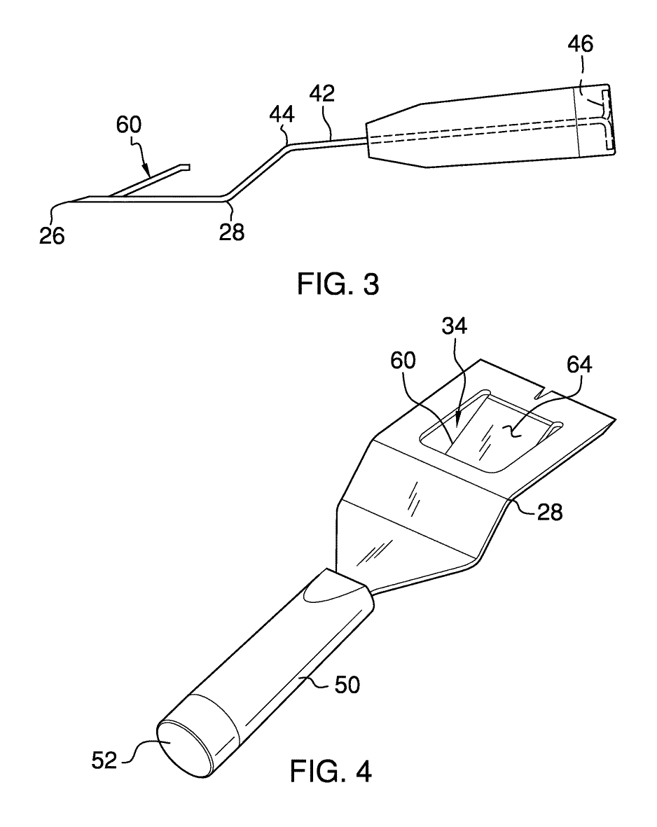

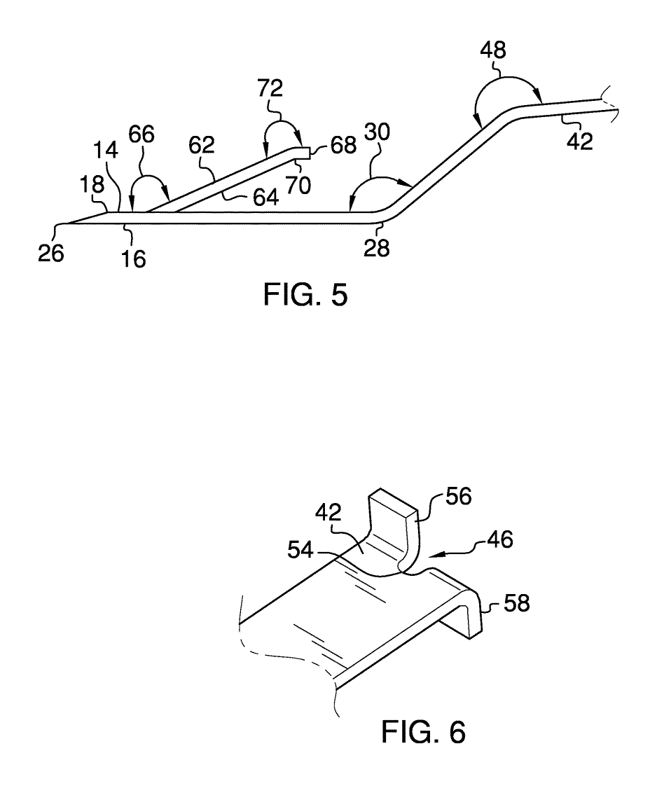

With reference now to the drawings, and in particular to FIGS. 1 through 6 thereof, a new wall trim removal device embodying the principles and concepts of an embodiment of the disclosure and generally designated by the reference numeral 10 will be described.

As best illustrated in FIGS. 1 through 6, the wall trim and molding removal tool assembly 10 generally comprises a panel 12, formed of a rigid material such as metal, having a top side 14 and a bottom side 16. The top side 14 includes a front edge 18, a rear edge 20, a first lateral edge 22, and a second lateral edge 24. The front edge 18 is angled downwardly from the top side 14 to the bottom side 16 such that a terminal edge 26 is defined at a juncture of the top side 12 and the bottom side 16 to form a sharpened edge, i.e. the terminal edge 26, having a height of less than 0.08 inches. The panel 12 has a bend 28 therein extending between the first 22 and second 24 lateral edges. The bend 28 forms an obtuse angle 30 in the top side 14 that is between 130° and 170°. The terminal edge 26 may have a notch 32 extending therein which is V-shaped. The notch 32 is equally spaced from the first 22 and second 24 lateral edges and is used for engaging nail heads for removing the nails.

The panel 12 has an opening 34 therein positioned between the bend 28 and the front edge 18. The opening 34 has a forward edge 36, a rearward edge 38, a first side edge 39 and a second side edge 40. The forward edge 36 is adjacent to the front edge 18 and is typically less than 1.0 inches from the front edge 18. A grip 42 is attached to the rear edge 20 and extends away therefrom. The grip 42 is angled upwardly from the rear edge 20. The grip 42 has an attached end 44 and free end 46 with respect to the panel 12. A longitudinal axis is defined extending through the attached 44 and the free 46 ends. An angle 48 formed at a juncture of the top side 14 and attached end 44 is between the 180° and 230°. The front edge 18 has a width from the first lateral edge 22 to the second lateral edge 24 between 3.5 inches and 4.5 inches. The panel 12 has a length from the front edge 18 to the bend 28 in the panel 12 between 3.0 inches and 4.0 inches and a length from the bend 28 in the panel 12 to the rearward edge 20 between 2.0 inches and 3.0 inches. The grip 42 may have a length depending on usage and in particular be between 6.0 inches and 9.0 inches when used on floor trim attached to walls while it may have a length between 30.0 inches and 50.0 inches when the assembly 10 is being used for harder to reach areas such as crown molding. The grip 42 may be covered by a handle 50 which terminates in a head 52, or cap. The head 52 may be comprised of a metallic material, such as steel, or an elastomeric material such that the head 52 may be struck with a mallet or hammer without damaging the assembly 10. The free end 46 may be formed by a slit 54 extending into the grip 42 to form an upwardly extending shoulder 56 and a downwardly extending shoulder 58 positioned opposite of the panel 12. The upwardly 56 and downwardly 58 extending shoulders are received by the head 52 and facilitate an impact force of a striking hammer to move through the grip 42 and into the panel 12 without bending or damaging the grip 42.

A tab 60 is attached to the forward edge 36 of the opening in the panel 12. The tab 60 is angled upwardly from the panel 12 and has an upper surface 62 and a lower surface 64. An angle 66 is formed between the upper surface 62 and the top side 14 that is between 135° and 175°. The tab 60 has a size to fit through the opening 34 and the opening 34 may have a length and width each being between 2.0 inches and 3.0 inches. The tab 60 has a distal edge 68 with respect to the forward edge 36. The tab 60 has a bend 70 therein positioned adjacent to the distal edge 68 and more specifically less than 0.25 inches from the distal edge 68. An angle 72 formed in the upper surface 62 by the bend 70 in the tab 60 is between 195° and 225°. The tab 60 has a length from the forward edge 36 to the distal edge 38 between 2.0 inches and 3.0 inches.

In use, the user extends the terminal edge 26 of the panel 12 between a wall surface and molding or trim attached to the wall. The user may, if needed, strike the free end 46 or heat 52 of the grip 42 to force the panel 12 between the wall and the trim. As the panel 12 moves between the trim and the wall, the tab 60 will begin to engage the trim and force it away from the wall. The panel 12 protects the wall from damage as the trim is forced away from the wall.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wall trim removal assembly configured to remove wall trim from a wall, said assembly comprising:
a panel having a top side and a bottom side, said top side including a front edge, a rear edge, a first lateral edge, and a second lateral edge, said front edge being angled downwardly from said top side to said bottom side such that a terminal edge is defined at a juncture of said top side and said bottom side forming a sharpened edge, said panel having a bend therein extending between said first and second lateral edges, said bend in said top side forming an obtuse angle in said top side;
said panel having an opening therein positioned between said bend and said front edge, said opening having a forward edge, a rearward edge, a first side edge and a second side edge, said forward edge being adjacent to said front edge;
a tab being attached to said forward edge of said opening in said panel, said tab being angled upwardly from said panel, said tab having an upper surface and a lower surface, an angle being formed between said upper surface and said top side being between 135° and 175°; and
a grip being attached to said rear edge and extending away therefrom.

2. The wall trim removal assembly according to claim 1, wherein said obtuse angle is between 130° and 170°.

3. The wall trim removal assembly according to claim 1, wherein said tab has a size to fit through said opening.

4. The wall trim removal assembly according to claim 1, wherein said tab has a distal edge with respect to said forward edge, said tab having a bend therein positioned adjacent to said distal edge, an angle formed in said upper surface by said bend in said tab being between 195° and 225°.

5. The wall trim removal assembly according to claim 1, wherein said grip is angle upwardly from said rear edge.

6. The wall trim removal assembly according to claim 5, wherein said grip has an attached end and free end with respect to said panel, a longitudinal axis being defined extending through said attached and said free ends, an angle formed at a juncture of said top side and attached end being between said 180° and 230°.

7. The wall trim removal assembly according to claim 1, wherein said front edge has a width from said first lateral edge to said second lateral edge between 3.5 inches and 4.5 inches, said panel having a length from said front edge to said bend in said panel between 3.0 inches and 4.0 inches, said panel having a length from said bend in said panel to said rearward edge between 2.0 inches and 3.0 inches.

8. The wall trim removal assembly according to claim 7, wherein said tab has a length from said forward edge to said distal edge between 2.0 inches and 3.0 inches.

9. The wall trim removal assembly according to claim 1, wherein said terminal edge has a notch extending therein, said notch being V-shaped, said notch being equally spaced from said first and second lateral edges.

10. A wall trim removal assembly configured to remove wall trim from a wall, said assembly comprising:
a panel having a top side and a bottom side, said top side including a front edge, a rear edge, a first lateral edge, and a second lateral edge, said front edge being angled downwardly from said top side to said bottom side such that a terminal edge is defined at a juncture of said top side and said bottom side forming a sharpened edge, said panel having a bend therein extending between said first and second lateral edges, said bend in said top side forming an obtuse angle in said top side and being between 130° and 170°;
said panel having an opening therein positioned between said bend and said front edge, said opening having a forward edge, a rearward edge, a first side edge and a second side edge, said forward edge being adjacent to said front edge;
a tab being attached to said forward edge of said opening in said panel, said tab being angled upwardly from said panel, said tab having an upper surface and a lower surface, an angle being formed between said upper surface and said top side being between 135° and 175°, said tab having a size to fit through said opening, said tab having a distal edge with respect to said forward edge, said tab having a bend therein positioned adjacent to said distal edge, an angle formed in said upper surface by said bend in said tab being between 195° and 225°;
a grip being attached to said rear edge and extending away therefrom, said grip being angle upwardly from said rear edge, said grip having an attached end and free end with respect to said panel, a longitudinal axis being defined extending through said attached and said free ends, an angle formed at a juncture of said top side and attached end being between said 180° and 230°;
said front edge having a width from said first lateral edge to said second lateral edge between 3.5 inches and 4.5 inches, said panel having a length from said front edge to said bend in said panel between 3.0 inches and 4.0 inches, said panel having a length from said bend in said panel to said rearward edge between 2.0 inches and 3.0 inches;
said tab having a length from said forward edge to said distal edge between 2.0 inches and 3.0 inches; and
said terminal edge having a notch extending therein, said notch being V-shaped, said notch being equally spaced from said first and second lateral edges.
